(19) United States
(12) Patent Application Publication
(10) Pub. No.: US 2007/0262092 A1
(43) Pub. Date: Nov. 15, 2007

(54) Fluid dispensing container

(76) Inventor: Wlodzimierz M. Tyski, Cheektowaga, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/433,006

(22) Filed: May 12, 2006

(51) Int. Cl. B65D 37/00; B65D 35/28; B67D 5/42

(52) U.S. Cl. 222/209; 222/95; 222/105; 222/386.5

(57) ABSTRACT

A container (15) for dispensing a fluid (16) comprising an outer flexible shell (18) having a dispensing port (19), an inlet (20) and an inner surface (21) defining a chamber (22) having a chamber volume, a collapsible receptacle (23) in the chamber configured and arranged to hold a fluid (16) and having an outer surface (24) and an inner surface (25) defining a storage volume (26), the shell and the receptacle defining an air volume (28) between the inner surface of the shell and the outer surface of the receptacle, the receptacle having an outlet (29) aligned with the shell dispensing port, a one-way check valve (30) in the shell inlet port configured to permit airflow (31) into the air volume and not into the holding volume and to block airflow out of the air volume, the shell, receptacle and valve configured and arranged such that a selective force applied to the outside of the shell decreases the chamber volume while the air volume remains substantially the same, thereby pressuring the fluid to exit the dispensing port in the holding volume to decrease as a function of the fluid exiting the dispensing port, the shell, receptacle and valve configured and arranged that when the force is released, the air volume increases while the holding volume remains substantially the same.

### TECHNICAL FIELD

The present invention relates generally to containers and, more particularly, to a container with an improved dispensing apparatus.

### BACKGROUND ART

A variety of containers for holding and dispensing products such as mustard, ketchup, sauces, and dressings are known in the prior art. Generally, such containers are flexible or deformable so that, when turned upside down, pressure applied to the outside of the container will deform the container and force the fluid out of the container. Thus, such containers are made of flexible or deformable plastic so that they may be squeezed to apply pressure to the fluid in the container and to force that fluid out of the exit port or nozzle of the container. However, containers in the prior art require that the container be turned upside down, the fluid to collect near the top of the container, and the container to be squeezed multiple times in order for high volumes of fluid to be dispensed. Essentially, air must be allowed to enter the container through the exit port before additional fluid may be dispensed from prior art containers. Also, the prior art containers need to be maintained upside down for a period of time for viscous fluid to fill the top of the container before it can be expelled. Hence, it would be beneficial to provide a container which has a dispensing mechanism that allows for the full volume of fluid in the container to be dispensed more easily.

### DISCLOSURE OF THE INVENTION

With parenthetical reference to the corresponding parts, portions or surfaces of the disclosed embodiment, merely for the purposes of illustration and not by way of limitation, the present invention provides a container (15) for dispensing a fluid (16) comprising an outer flexible shell (18) having a dispensing port (19), an inlet (20) and an inner surface (21) defining a chamber (22) having a chamber volume, a collapsible receptacle (23) in the chamber configured and arranged to hold a fluid (16) and having an outer surface (24) and an inner surface (25) defining a storage volume (26), the shell and the receptacle defining an air volume (28) between the inner surface of the shell and the outer surface of the receptacle, the receptacle having an outlet (29) aligned with the shell dispensing port, a one-way check valve (30) in the shell inlet port configured to permit airflow (31) into the air volume and not into the holding volume and to block airflow out of the air volume, the shell, receptacle and valve configured and arranged such that a selective force applied to the outside of the shell decreases the chamber volume while the air volume remains substantially the same, thereby pressuring the fluid to exit the dispensing port in the holding volume to decrease as a function of the fluid exiting the dispensing port, the shell, receptacle and valve configured and arranged that when the force is released, the air volume increases while the holding volume remains substantially the same. The shell may have a bottom portion and the inlet may extend through the bottom portion. The shell may have a top portion (33) and the inlet may be located in the top portion. The shell may be configured and arranged to have an initial steady-state chamber volume and to return to the steady-state chamber volume when the force is released. The receptacle may have an axial dimension (34) and a radial dimension (35) and may further comprise a support member (36) configured and arranged to substantially maintain the axial dimension as the holding volume decreases. The shell and the receptacle may be configured and arranged such that the receptacle may be removed from the shell and replaced with the a second receptacle. The fluid may be selected from a group consisting of ketchup, mustard, salad dressing, toothpaste, shampoo, moisturizer and soap. The valve may be selected from a group consisting of a ball check valve, a wafer check valve and a diaphragm check valve.

Accordingly, the general object of the present invention is to provide an improved container which allows for fluid in the container to be easily and evenly dispensed from initial use until all the fluid in the container has been expelled.

Another object is to provide a container in which isolates the fluid being dispensed from ambient air in the container.

Another object is to provide a container which limits contamination of the fluid inside the container.

Another object is to provide a container which maintains its general shape even as the fluid in the container is dispensed.

These and other objects and advantages will become apparent from the foregoing and ongoing written specification, the drawings, and the appended claims.

### BRIEF DESCRIPTION OF THE DRAWINGS

FIG. 1 is a perspective view of the improved container.

FIG. 2 is a perspective view of the container shown in FIG. 1 with fluid being dispensed from the container.

FIG. 3 is a perspective view of the container shown in FIG. 2 after fluid has been dispensed.

FIG. 4 is a front view of the container shown in FIG. 1.

FIG. 5 is a vertical longitudinal sectional view of the container shown in FIG. 1.

FIG. 6 is a vertical longitudinal sectional view of the container shown in FIG. 2.

FIG. 7 is a vertical longitudinal sectional view of the container shown in FIG. 3.

FIG. 8 is a horizontal transverse sectional view of the container shown in FIG. 4, taken generally on line 8-8 of FIG. 4.

FIG. 9 is a perspective view of the inner receptacle and support member of the container shown in FIG. 5.

FIG. 10 is a side view of the support member shown in FIG. 9.

FIG. 11 is a top plan view of the support member shown in FIG. 10.

FIG. 12 is a enlarged detailed view of the container shown in FIG. 5, taken within the indicated circle of FIG. 5.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

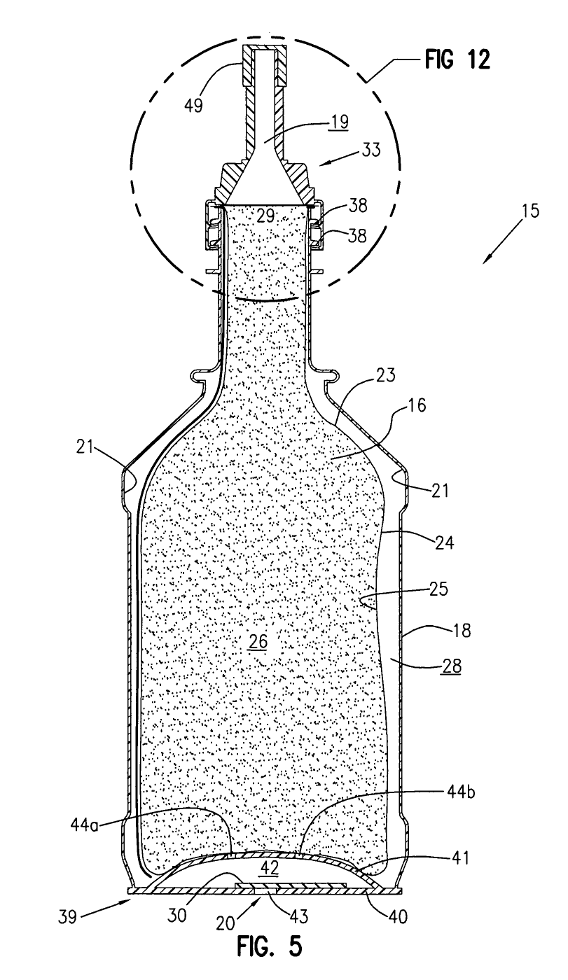

Referring now to the drawings and, more particularly, to FIG. 5 thereof, this invention provides an improved fluid dispensing container, of which the presently preferred embodiment is generally indicated at 15. Container 15 is shown as broadly including an outer shell 18 and an inner receptacle 23 filled with and containing a fluid 16.

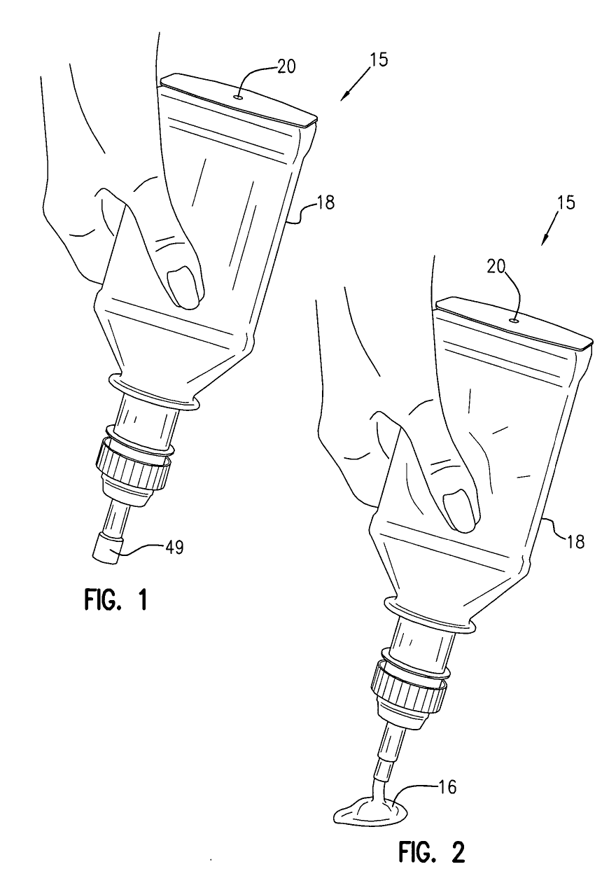

Shell 18 is generally a conventional plastic bottle made of plastic and having an inner chamber 22 of a given volume when the shell is not deformed. Shell 18 behaves elastically such that it returns to its original shape after normal deformation from being squeezed by a user. FIGS. 1 and 5 show shell 18 in this non-deformed unloaded steady state. As shown in FIGS. 5 and 12, shell 18 has a lower body portion and an upper neck portion having outer threads 38. Top 33 has corresponding inner threads such that it may be screwed over the open neck of shell 18. A dispensing port 19 is configured to dispense fluid 16 from chamber 22.

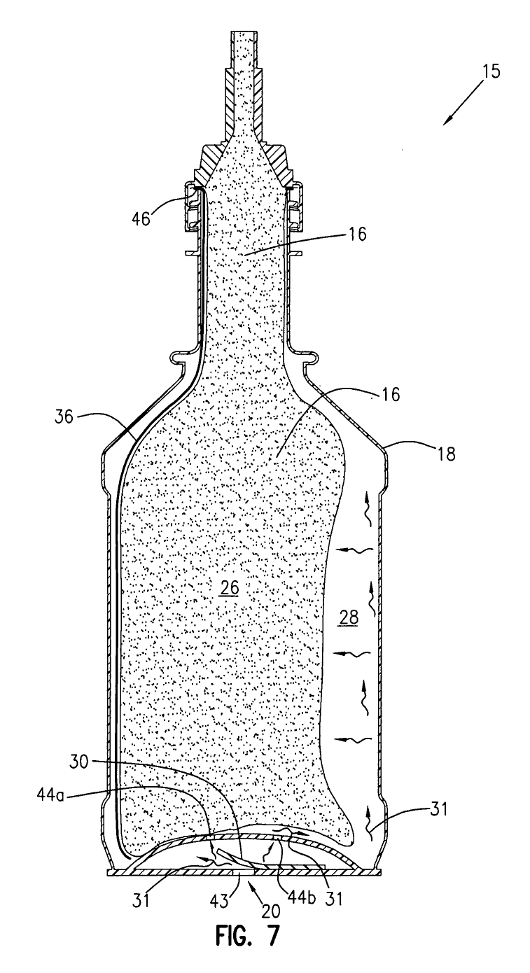

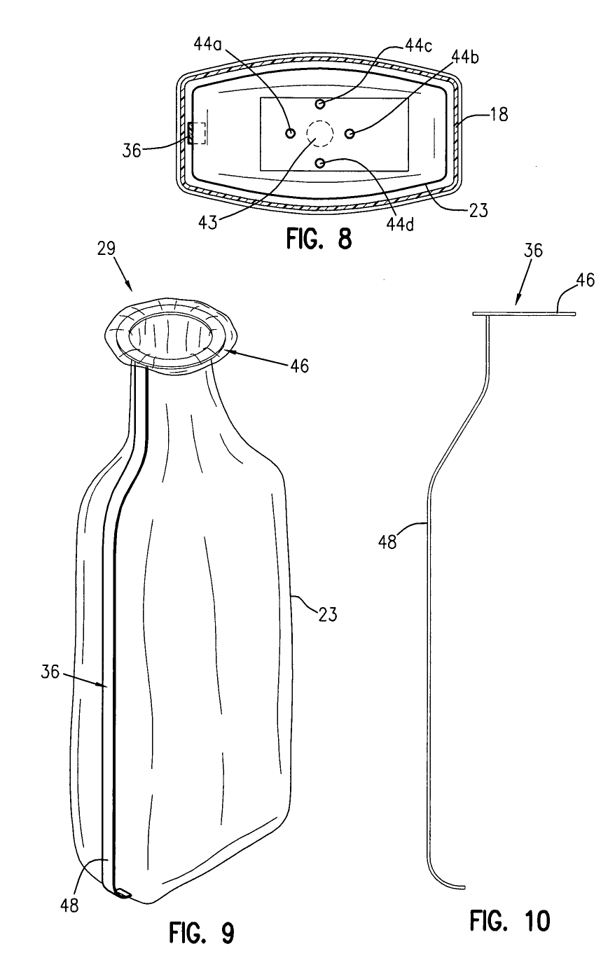

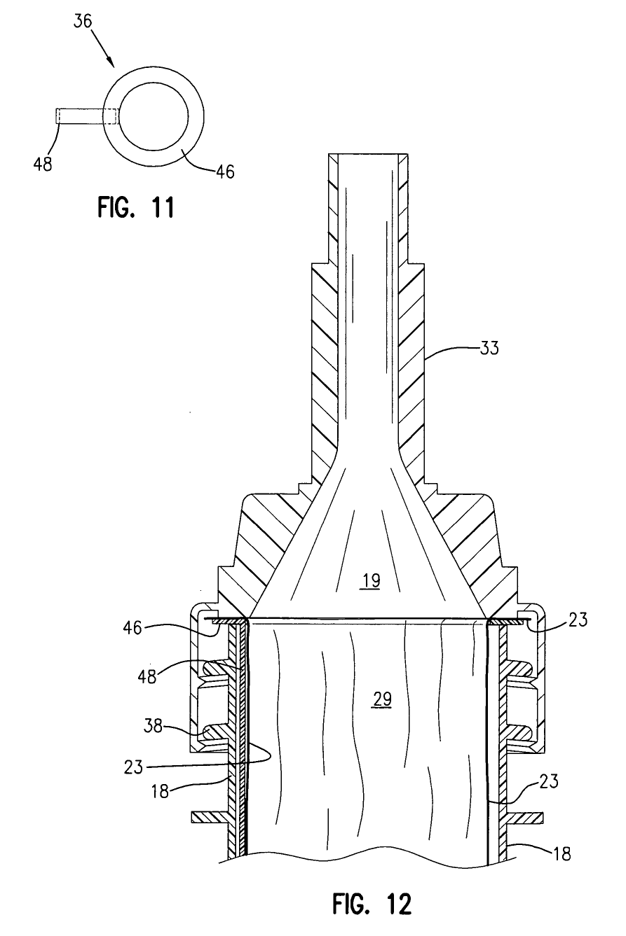

However, unlike conventional plastic bottles, shell 18 includes a bottom portion 39 having an inlet 20 between the outside of shell 18 and chamber 22. Inlet 20 in turn includes a one way valve 30 which permits ambient air to flow, as shown in FIG. 7, from the outside of shell 18 into chamber 22, but does not permit airflow in the opposite direction. As shown in FIGS. 5-7, in the preferred embodiment inlet 20 comprises a bottom member 40 and a top curved shell portion 41 joined at its outer edge to the outer peripheral edge of bottom member 40. Shell portion 41 and member 40 define a valve chamber 42 therebetween. As shown in FIGS. 5 and 8, bottom member 40 includes a port 43 between valve chamber 42 and the outside of shell 18. Four ports 44a-d extend through shell portion 41 and allow for open communication between valve chamber 42 and shell chamber 22. In the preferred embodiment, ports 44a-d are open and do not include any valves that restrict airflow 31.

A one-way valve 30 is configured to extend over the inside of port 43. Valve chamber 42 provides space for valve 30 to flex inwardly to allow for airflow 31 into chamber 22. Valve 30 springs closed in the absence of airflow or if the airflow reverses. Thus, valve 30 only allows one-way airflow 31 in through port 43. While the preferred embodiment employs a diaphragm valve 30 and a valve chamber 42 to only permit airflow into chamber 22, it is contemplated that other one-way valves me be employed as alternatives. For example, shell portion 41 could be removed and a ball check valve used to restrict flow through port 43, or a wafer check valve may be employed.

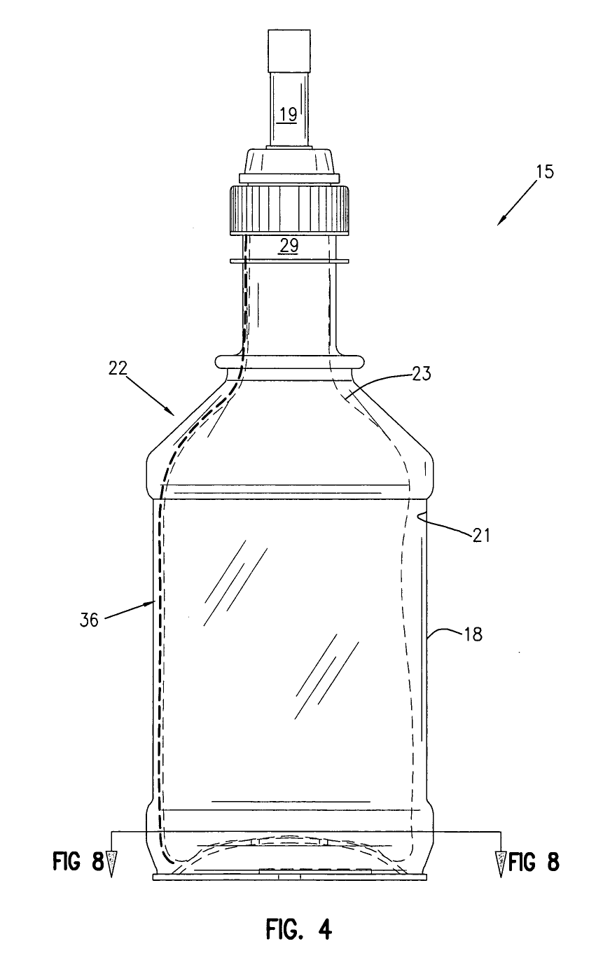

As shown in FIGS. 4, 5-7 and 9, receptacle 23 is a balloon-like membrane having an open end 29 and an inner storage volume 26. As shown in FIGS. 4-7, receptacle 23 is adapted to be filled with and to retain fluid 16. Fluid 16 may be any viscous fluid such as ketchup, mustard, salad dressing, oil, toothpaste, shampoo, moisturizer, soap and the like. Receptacle 23 is a collapsible membrane that will not retain its shape as fluid is dispensed and the receptacle is unloaded.

As shown in FIG. 12, the open end of receptacle 23 is circumferentially affixed to the open end of the neck of shell 18 so that outlet 29 and dispensing port 19 are aligned. Outlet 29 of receptacle 23 is affixed to the inner cylindrical edge of the open neck of shell 18. The end of receptacle 23 may be stretched over and around the open end of the neck and/or otherwise attached.

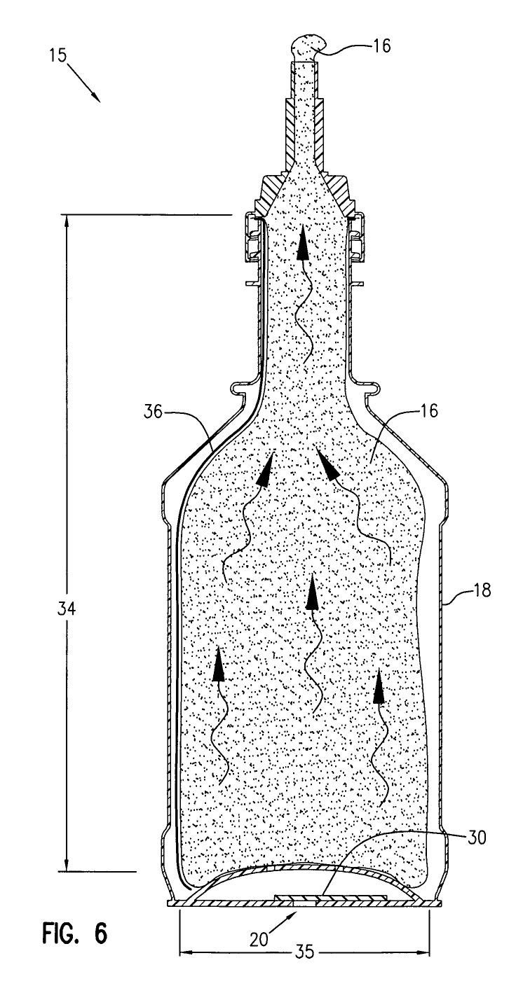

The body of receptacle 23 extends into shell chamber 22. When filled, the shape of receptacle 23 generally conforms to the shape of shell 18. Receptacle 23 is wider at the bottom and narrows to align with the neck of shell 18 at the top. As shown in FIG. 6, receptacle 23 has an axial length 34 and a maximum width 35 when filled.

As shown in FIGS. 9 and 10, in the preferred embodiment receptacle 23 includes a support member 36. Because receptacle 23 is a collapsible membrane that does not retain its original shape, as fluid 16 is dispensed from receptacle 23, the membrane will collapse. Membrane 36 is provided so that receptacle 23 will not form pockets as it collapses with the dispensing of fluid 16. Thus, member 36 supports receptacle 23 in the axial direction but not in the radial or transverse direction. Member 36 is a rigid member having a support arm 48 extending generally perpendicularly from an annular attachment rim 46. As shown in FIG. 12, rim 46 is supported at the opening of the neck of shell 18. Rim 46, the open annular end of receptacle 23 and the open annular end of the neck of shell 18 are concentrically aligned. Support arm 48 is connected to and supported by rim 46 and extends into chamber 22, generally following the contour of shell 18, from the open end of the neck of shell 18 to the bottom of shell 18. The open end of receptacle 23 wraps over rim 46 of member 36 and the other end of receptacle 23 is attached to the bottom end of support arm 48. Accordingly, member 36 is configured and arranged to substantially maintain the axial dimension of receptacle 23 in shell 18. Support 36 allows for receptacle 23 to collapse in radial dimension 35 towards arm 48 but holds receptacle 23 from collapsing in axial dimension 34. This facilitates the full dispensing of fluid 16 from receptacle 23.

As shown in FIGS. 5-7, receptacle 23 and shell 18 are configured and arranged to provide two sub-chambers or sub-volumes within shell chamber 22 so as to provide a better dispensing mechanism. As described above, shell 18 is a plastic bottle having an inner surface 21 that defines an inner chamber 22 of a given volume. Receptacle 23 is adapted to be filled with fluid 16. Receptacle 23 has an inner surface 25 that defines storage volume 26. The space between the outer surface 24 of receptacle 23 and the inner surface 21 of shell 18 defines an air volume 28. No communication of air or fluid is provided between storage volume 26 and air volume 28 and storage volume 26 and air volume 28 make up shell volume 22.

FIGS. 1-3 and corresponding FIGS. 5-7, respectively, show the dispensing mechanism of container 15. FIGS. 1 and 5 show container 15 with cap 49 on and filled without any external force applied. As shown, shell 18 is at steady state and has not been deformed by any external force. Chamber 22 of shell 18 is at its greatest intended volume and receptacle 23 is substantially filled with fluid 16 such that storage volume 26 is at its greatest intended volume and air volume 28 is at its lowest intended volume.

FIGS. 2 and 6 show container 15 with cap 49 removed and force applied to the outside of shell 18. As shown in FIG. 2, after removing cap 49 the user squeezes the outside of container 15 in a conventional manner to dispense fluid 16. As shown in FIG. 6, the outside pressure on shell 18 causes fluid 16 to be immediately dispensed through port 19. This is because air cannot exit port 20 due to one way check valve 30. The force applied on the outside of shell 18 decreases chamber volume 22 and, because air volume 28 remains substantially constant due to one way check valve 30, the force applied to the outside of shell 18 immediately pressurizes receptacle 26 and forces fluid to exit dispensing port 19. With the dispensing of fluid 16, receptacle 23 collapses and holding volume 26 decreases as a function of the fluid 16 exiting dispensing port 16.

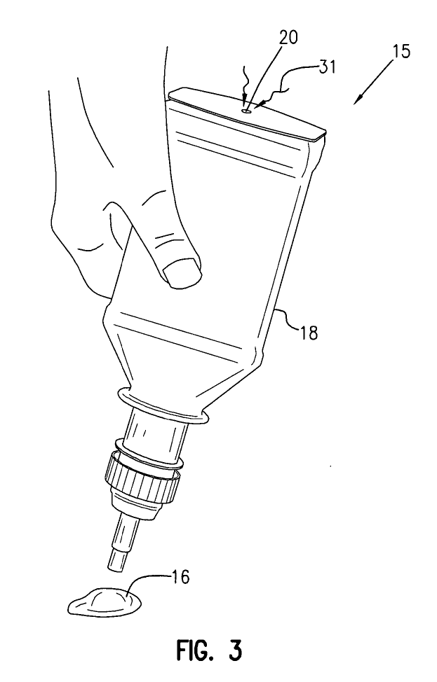

FIGS. 3 and 7 show container 15 after the user has stopped squeezing container 15 and it returns elastically to its initial condition. As a result of the release of force against the outside of shell 18, shell 18 will want to return to its non-deformed steady state and to it initial chamber volume 22. This creates a vacuum that causes air to flow through port 43 into air volume 28 of chamber 22 through ports 44a-d. As shown, receptacle 23 and shell 18 are configured such that the air entering through ports 44a-d increases air volume 28 but not storage volume 26. Thus, rather than storage volume 26 expanding to its initial volume, air volume 28 increases instead. Thus, after fluid 16 is dispensed, air is allowed to enter air volume 28 and air volume 28 increases relative to the volume shown in FIG. 5. Correspondingly, storage volume 26 is less than the volume shown in FIG. 5. As a result, when the user squeezes container 15 a second time, fluid 16 is immediately dispensed because air volume 28, which is now greater, remains substantially constant due to one way check valve 30 and the new force applied to the outside of shell 18 will immediately pressurize receptacle 26 and force fluid to exit dispensing port 19.

This results in a number of advantages. First, when the user wishes to dispense additional fluid, he or she does not need to exert increasing amounts of force to the outside of shell 18 to have the remaining volume of fluid 16 dispensed. Second, by having two separate sub-chambers 26 and 28 in chamber 22, and an inlet 20 with a one way check valve 30 between the outside of shell 18 and just one of such sub-chambers, receptacle 23, which holds fluid 16, does not become filled with any air, which can interrupt the dispensing ability of container 15. Instead, receptacle 23 collapses such that its holding volume 26 is filled entirely with fluid 16. In this way, the next time container 15 is used to dispense fluid, the container does not need to be held upside down to force fluid into the neck and toward the dispensing port 19 of the container. Nor does the user have to squeeze the bottle repeatedly in order to get fluid 16, rather than air, out of dispensing port 19. Instead, the same force applied to the outside of the container results in a consistent amount of fluid exiting dispensing port 19. Fluid 16 may be dispensed easily and evenly from initial use until all the fluid in the container has been expelled.

It is contemplated that shell 18 and receptacle 23 may be configured such that the receptacle can be removed after it is empty and replaced with a second filled receptacle. In this way, the same outside container or shell may be refilled and reused. In addition, although the improved embodiment describes an inlet and one-way check valve in the bottom of the container, it is contemplated that the inlet and one-way check valve between the outside of the container and the air volume may be located through other places, such as the side or the top of the container.

The present invention contemplates that many changes and modifications may be made. Therefore, while the presently-preferred form of the container as been shown and described, and a number alternatives discussed, persons skilled in this art will readily appreciate that various additional changes and modifications may be made without departing from the spirit of the invention, as defined and differentiated by the following claims.

What is claimed is:

1. A container for dispensing a fluid comprising:
an outer flexible shell having a dispensing port, an inlet and an inner surface defining a chamber having a chamber volume;
a collapsible receptacle in said chamber configured and arranged to hold a fluid and having an outer surface and an inner surface defining a storage volume;
said shell and said receptacle defining an air volume between said inner surface of said shell and said outer surface of said receptacle;
said receptacle having an outlet aligned with said shell dispensing port;
a one-way check valve in said shell inlet port configured to permit airflow into said air volume, and not into said holding volume, and to block airflow out of said air volume;
said shell, receptacle and valve configured and arranged such that a selective force applied to the outside of said shell decreases said chamber volume while said air volume remains substantially the same, thereby pressuring said fluid to exit said dispensing port and said holding volume to decrease as a function of said fluid exiting said dispensing port;
said shell, receptacle and valve configured and arranged such that when said force is released, said air volume increases while said holding volume remains substantially the same.

2. The claim set forth in claim 1, wherein said shell has a bottom portion and said inlet extends through said bottom portion.

3. The container set forth in claim 1, wherein said shell has a top portion and said inlet is located in said top portion.

4. The container set forth in claim 1, wherein said shell is configured and arranged to have an initial steady-state chamber volume and to return to said steady-state chamber volume when said force is released.

5. The container set forth in claim 1, wherein said receptacle has an axial and a radial dimension and further comprising a support member configured and arranged to substantially maintain said axial dimension as said holding volume decreases.

6. The container set forth in claim 1, wherein said shell and said receptacle are configured and arranged such that said receptacle may be removed from said shell and replaced with a replacement receptacle.

7. The container set forth in claim 1, wherein said fluid is selected of a group consisting of ketchup, mustard, salad dressing, oil, toothpaste, shampoo, moisturizer and soap.

8. The container set forth in claim 1, wherein said valve is selected from a group consisting of a ball check valve, a wafer check valve and a diaphragm check valve.
